(19) United States
(12) Patent Application Publication
(10) Pub. No.: US 2011/0051713 A1
(43) Pub. Date: Mar. 3, 2011

(54) FACSIMILE PRIORITIZATION WITHIN INTERNET PROTOCOL CALL NETWORKS

(75) Inventors: Sahadevasangary Gajedevasangary, Hertfordshire (GB); Maysara Fermawi, Herts (GB); Martin Roantree, Herts (GB); Joanna Keep, Hertfordshire (GB); Alex Cheshire, Hertfordshire (GB)

(73) Assignee: XEROX CORPORATION, Norwalk, CT (US)

(21) Appl. No.: 12/548,508

(22) Filed: Aug. 27, 2009

(51) Int. Cl. H04L 12/66; H04M 11/00

(52) U.S. Cl. 370/352; 379/100.01

(57) ABSTRACT

A method and apparatus maintain a facsimile number priority hierarchy within a computer storage medium and process a first facsimile call being transmitted through a computerized call processor. The first facsimile call is made between a first telephone number associated with the computerized call processor and a second telephone number not associated with the computerized call processor. While processing the first facsimile call, the computerized call processor receives an indication of an attempt to connect a second facsimile call between the first telephone number and a third telephone number. The third telephone number is not associated with the computerized call processor. The method and apparatus determine a priority between the second telephone number and the third telephone number based on the facsimile number priority hierarchy. If the second telephone number has a higher priority than the third telephone number, the computerized call processor does not connect the second facsimile call. However, if the third telephone number has a higher priority than the second telephone number, the computerized call processor terminates the first facsimile call and connects the second facsimile call by connecting the third telephone number to the first telephone number.

### BACKGROUND AND SUMMARY

Embodiments herein generally relate to methods and apparatuses that process facsimiles and more particularly, concern a method and system that prioritizes the sending and receipt of facsimiles and terminates lower priority facsimiles in order to ensure that high priority facsimiles are processed.

In organizations that use facsimiles heavily, there is a risk that important or urgent facsimile messages may not be received in time if the facsimile machine is in constant use. In fact, if the receiving machine is too busy it is possible that important facsimile calls may not be received at all if the maximum number of redial attempts is reached on the calling terminal, and the call is automatically cancelled by the sending machine.

With traditional analogue facsimile technology, using public telephone networks, a standard line cannot receive more than one facsimile call at a time. If the line is busy, the exchange informs the sending terminal that this is the case. For analogue systems with call waiting, if the call is not answered, the call could be forwarded to a busy signal or call waiting; and the callee would not be provided with the caller ID of the new caller.

However, with internet-based telephone technologies, such as voice/facsimile over internet protocol (VoIP/FoIP) technologies, the decision of whether the VoIP terminal is busy, lies with the VoIP terminal itself. When the new call comes in, the FoIP aware facsimile terminal is informed of the Caller ID and can make the decision regarding whether to accept the incoming call.

The embodiments herein capitalize upon these evolving VoIP/FoIP features and, in one exemplary embodiment, provide a computer-implemented method that maintains a facsimile number priority hierarchy within a computer storage medium. The method processes a first facsimile call being transmitted through a computerized call processor. (The computerized call processor is operatively connected to (directly or indirectly connected to) the computer storage medium.) The “first” facsimile call is made between a first telephone number associated with the computerized call processor and a second telephone number not associated with the computerized call processor.

While processing the first facsimile call, the computerized call processor often receives an indication of an attempt to connect a “second” facsimile call between the first telephone number and a third telephone number. The third telephone number is also not associated with the computerized call processor. It is assumed in this example that there is insufficient processing bandwidth (because of hardware and software capacity limitations) within the computerized called processor to process both call simultaneously. While conventional systems would simply not connect the second facsimile call (would provide a busy or other similar signal indicating that the call cannot be completed or add an outgoing call to a queue); embodiments herein break away from such conventional teachings by evaluating whether to terminate the first facsimile call depending upon the relative priorities between the first and second facsimile calls. By so doing, embodiments herein always allow high priority facsimile transmissions to be completed at the expense of lower priority facsimile transmissions.

In order to perform such action, the embodiments herein determine the priority between the second telephone number and the third telephone number based on the facsimile number priority hierarchy, using the computerized call processor. If the second telephone number has a higher priority than the third telephone number, the computerized call processor does not connect the second facsimile call (by returning a busy indicator to the third telephone number in response to the attempt to connect). To the contrary, if the third telephone number has a higher priority than the second telephone number, the computerized call processor terminates the first facsimile call and connects the second facsimile call (by connecting the third telephone number to the first telephone number).

In one example, the method determines the priority by: ranking telephone numbers not maintained within the facsimile number priority hierarchy equally; ranking telephone numbers maintained within the facsimile number priority hierarchy higher than numbers not maintained within the facsimile number priority hierarchy; and determining a ranking between telephone numbers maintained within the facsimile number priority hierarchy according to a structure of the facsimile number priority hierarchy.

The embodiments herein are applicable to incoming and outgoing calls and work especially well with dedicated facsimile telephone numbers. Therefore, the first facsimile call and the second facsimile call can comprise either a call originated by the first telephone number or a call received by the first telephone number. After terminating the first facsimile call (and after completing the second facsimile call) method embodiments herein can resend the first facsimile call, if the first facsimile call was originate by the first telephone number.

### BRIEF DESCRIPTION OF THE DRAWINGS

Various exemplary embodiments of the systems and methods are described in detail below, with reference to the attached drawing figures, in which:

FIG. 1 is a flowchart illustrating aspects of embodiments herein;

FIG. 2 is a flowchart illustrating aspects of embodiments herein; and

FIG. 3 is a schematic diagram of a system embodiment herein.

### DETAILED DESCRIPTION

As mentioned above, in heavily used facsimile environments, high priority facsimiles are often delayed or not received because lower-priority facsimiles occupy the bandwidth. In order to address this, embodiments herein provide methods that enable the user to give priority to selected known senders and to urgent/important facsimile messages. Internet-based telephone (telephony) systems are tremendously flexible and can often handle many calls simultaneously. Such systems are very adept at facsimile transmissions. For example, see U.S. Pat. No. 7,545,818 entitled “Method and system for detecting facsimile communication during a VoIP session” (fully incorporated herein by reference) for a general discussion of such internet-based telephone systems.

However, at some point, regardless of the capacity of the telephone system, the number of available lines (bandwidth) will be less than the number of calls or facsimile transmissions that are requested simultaneously (because of hardware and software capacity limitations). In this situation, the present embodiments provide an automated system and method to prioritize the sending and receiving of facsimile transmissions so that higher-priority users are permitted to send and receive facsimiles at the expense of other lower-priority users.

The embodiments herein use internet protocol telephone/facsimile systems, such as VoIP/FoIP technology to make decisions as to whether the called number is busy. When a new facsimile call attempts to form a connection, a VoIP aware facsimile terminal is also informed of the Caller ID and can make the decision regarding the call. With embodiments herein, the VoIP facsimile terminal has the ability to cease a call being currently processed in order and to connect a higher priority new call.

With embodiments herein, if no extra lines are available, and a user desires to send a facsimile to, or receive a facsimile from, a previously registered high priority telephone number, a currently processed facsimile transmission can be canceled to allow the communication with the high priority telephone number to be established. With the common ability of facsimile equipment to automatically resend incomplete facsimile transmissions, the interruption of the lower-priority facsimile transmission generally will not result in substantial disadvantages because such lower priority facsimile transmissions will eventually be completed through the automated resending process.

Further, even if extra lines are available, the embodiments herein can make priority decisions to maximize the usage of high priority telephone numbers. For example, embodiments herein can utilize a hierarchy of priority with respect to the different telephone numbers. Some ultra-high priority telephone numbers may have unrestricted ability to cause another call to be terminated, while medium priority telephone numbers may only be allowed to interrupt other calls at certain times of day, etc.

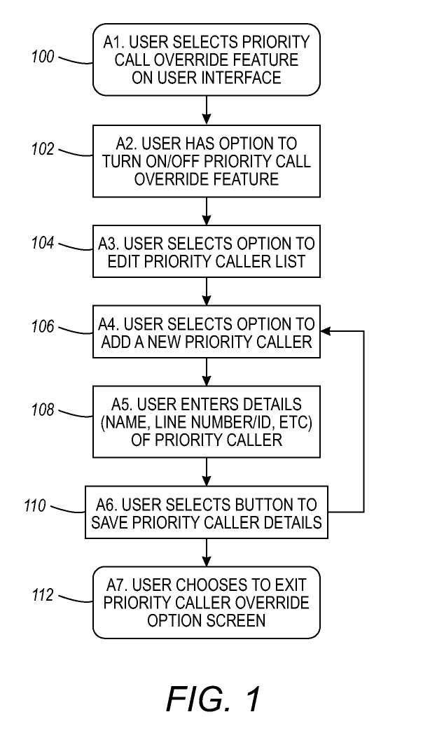

The user has the option to enable these features and to configure an address/number list of priority callers. For example, as shown in flowchart form in FIG. 1, in item 100, the user can select a priority call override feature on a user interface. Thus, as shown in item 102, the user has the option to turn the priority call override feature on or off.

In addition, the user can edit the priority caller list as shown in item 104. Thus, as shown in item 106, the user can select an option on the graphic user interface to add a new priority caller. In item 108, the user enters the various details (name, line number/ID, etc.) of the priority caller and the user's level of priority (such as ultra-high, high, medium, low, etc.). The information maintained regarding a priority can be as simple as a single telephone number or as complex as necessary including multiple telephone numbers, multiple addresses, multiple names, etc. In item 110, the user selects a button on the graphic user interface to save the priority caller details and this process can loop back up to item 106 as often as necessary. In item 112, the user can exit the priority call override option screen from the graphic user interface.

If the Caller ID of the new incoming facsimile caller (or outgoing call number) matches one of the numbers in the priority callers list, the computerized call apparatus will automatically hold or suspend the current incoming or outgoing call and connect the new call (if the current call is from a caller who is not within the priority caller list or who has a lower priority than the new call). Further, with embodiments herein, bandwidth can be allocated to multiple jobs based on job priority, calls from some numbers could be always rejected (no-answer list), printing priority could be controlled, and so on.

The features herein enable a user to give call priority to selected known senders. For example, a facsimile transmission delay or cancellation can be very expensive if a high-ranking official is waiting for an urgent facsimile from another high-ranking official on a very busy facsimile machine (that may be completely occupied receiving facsimiles from non-priority callers). Absent the present embodiments, such high-ranking officials may unnecessarily purchase extra facsimile equipment, utilize relatively more expensive couriers, etc., which can be wasteful in the long run.

The embodiments herein give such high-ranking officials priority over other users by allowing the internet protocol systems to cancel the lower ranking connections when one of the high-ranking officials initiates a transfer. This is possible because with VoIP/FoIP technology the decision of whether the terminal is busy, lies with the terminal itself. When the new call comes in the internet protocol aware facsimile terminal is also informed of the Caller ID and can take the decision to interrupt a current call and answer the new one (or to answer both, or as many calls as processing power allows).

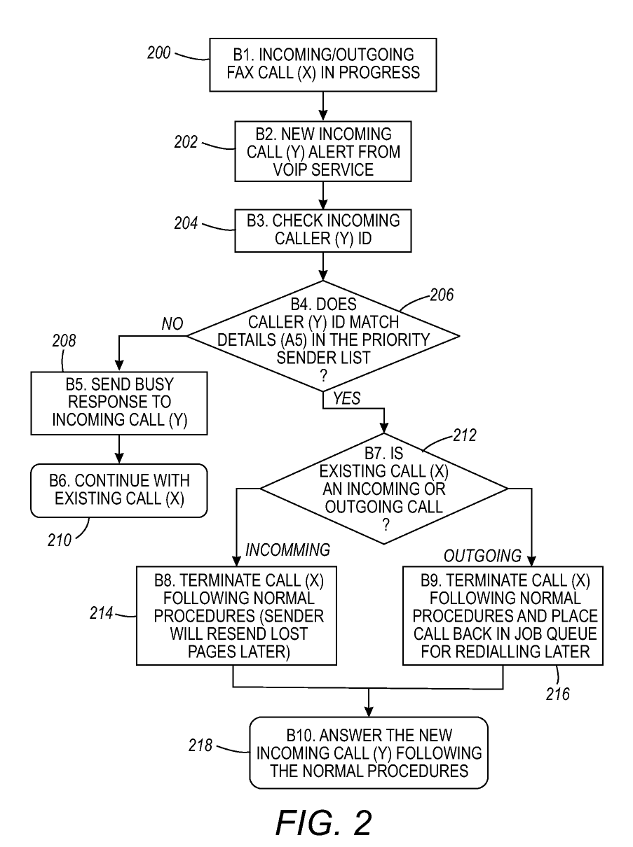

More specifically, as shown in flowchart form in FIG. 2, one exemplary embodiment herein processes (in item 200) a first facsimile call (X) being transmitted through an internet-based telephone protocol (e.g., VoIP, etc.) computerized call processor. The first facsimile call is made between a first telephone number based in the computerized call apparatus and a second telephone number that is not based in the computerized call apparatus. As shown in item 202, while processing the first facsimile call, the method receives an indication (incoming call alert) of an attempt to connect a second facsimile call (Y) between the first telephone number and a third telephone number using the VoIP computerized call processor. The third telephone number is different than the second telephone number and is also not based in the computerized call apparatus.

In item 204, the caller ID of the incoming call is identified or the called number of a new outgoing facsimile transmission is identified as the third telephone number. As mentioned above, the embodiments herein maintain facsimile number priority hierarchy file(s) within a computer storage medium of the VoIP computerized call apparatus. This allows the embodiments (in item 206) to determine a priority between the second telephone number and the third telephone number.

As shown in item 208, if the second telephone number has a higher priority than the third telephone number, the VoIP computerized call processor does not connect the second facsimile call by returning a busy indicator in response to the attempt to connect. For outgoing calls that do not have a higher priority, such facsimile transmissions are merely added to an outgoing facsimile queue. Then, the process continues with the existing first facsimile call in item 210.

To the contrary, as shown in item 212, if the third telephone number has a higher priority than the second telephone number, the embodiments herein determine whether the call was an incoming or outgoing call. If the call is an incoming call, in item 214, the VoIP computerized call processor terminates the first facsimile call in response to which the sender's facsimile equipment will resend the lost pages at a later time. If the call is an outgoing call, in item 216, the method terminates the call and places the call back in the job queue for redialing later. In either case, in item 218, the methods herein connect the second facsimile call by connecting the third telephone number to the first telephone number.

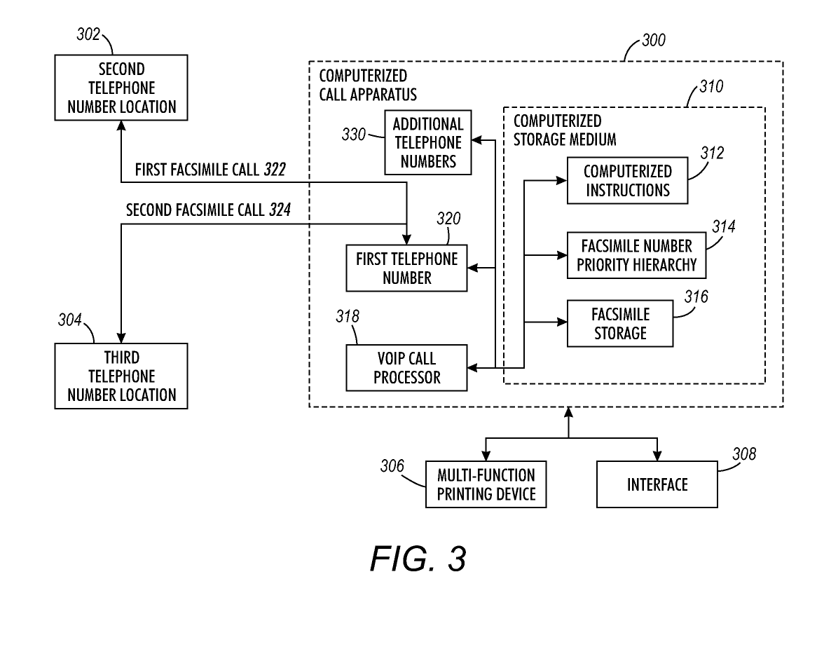

FIG. 3 is a schematic system diagram illustrating one exemplary embodiment. Those ordinarily skilled in the art would understand that many different modifications and options are available as additions to (or alternatives to) those shown in FIG. 3. For example, FIG. 3 illustrates two different callers 302, 304 attempting to connect to a single caller 320; however, those skilled in the art would understand that many more callers and recipients (e.g., 330) could be involved. For example, item 330 represents additional telephone numbers that may be available to the computerized call apparatus 300. These additional telephone numbers may represent actual physical lines and/or additional logical lines created by the computerized call apparatus 300.

More specifically, as shown in FIG. 3, this exemplary embodiment includes a computerized call apparatus 300 such as a voice-over-internet-protocol (VoIP) computerized call apparatus. The computerized call apparatus 300 can comprise any computerized device that has the ability to process telephone calls including, but not limited to, mainframe computers, file server computers, desktop computers, laptop computers, telephones, facsimile machines, multi-function machines, VoIP smart boxes, etc. The apparatus 300 includes a computer storage medium 310 that maintains many different items (files). For example, the computer storage medium 310 can maintain a facsimile number priority hierarchy 314, a program of instructions 312, facsimile storage 316, etc. As mentioned above, the facsimile number priority hierarchy 314 is utilized to evaluate which facsimile calls to connect when there are a limited number of lines available.

The computerized instructions 312 comprise software programs, specialized instructions, data, etc., that are executed and used by the call processor 318 in order to perform the different methodology and functions that are described in this disclosure. The facsimile storage 316 is utilized as a buffer to hold the facsimiles that are received until they can be viewed by a user through the user or network interface 308, and/or printed using the multi-function printing device 306.

The VoIP computerized call processor 318 is operatively connected to (directly or indirectly connected to) the computer storage medium 310, the multi-function printing device 306, the interface 308, as well as to external connections that can connect to different telephone lines 302, 304. As mentioned above, the VoIP computerized call processor 318 executes the program of instructions 312 to process a first facsimile call 322 being transmitted through of the VoIP computerized call apparatus. The first facsimile call 322 is made between a first telephone number 320 based in the computerized call apparatus 300 and a second telephone number 302 not based in (based outside) the computerized call apparatus 300.

While processing the first facsimile call 322, the computerized call apparatus 300 receives an indication of an attempt to connect a second facsimile call 324 (incoming or outgoing) between the first telephone number 320 and a third telephone number 304 using the VoIP computerized call processor 318. The third telephone number 304 is also not based in the computerized call apparatus 300.

The embodiments herein determine the priority between the second telephone number 302 and the third telephone number 304 based on the facsimile number priority hierarchy 314, using the VoIP computerized call processor 318. More specifically, if the second telephone number 302 has a higher priority than the third telephone number 304, the VoIP computerized call processor 318 executes the program of instructions 312 to not connect the second facsimile call 324 by returning a busy indicator in response to the attempt to connect. If the third telephone number 304 has a higher priority than the second telephone number 302, the VoIP computerized call processor 318 executes the program of instructions 312 to terminate the first facsimile call 322 and connect the second facsimile call 324 by connecting the third telephone number 304 to the first telephone number 320.

The computerized call processor 318 can determine the priority in a number of different ways. For example, the computerized call processor 318 can rank telephone numbers not maintained within the facsimile number priority hierarchy equally. Further, the computerized call processor 318 can rank telephone numbers maintained within the facsimile number priority hierarchy higher than numbers not maintained within the facsimile number priority hierarchy. Also, the computerized call processor 318 can rank telephone numbers that are both maintained within the facsimile number priority hierarchy according to a structure of the facsimile number priority hierarchy (e.g., ultra-high, medium-high, high, medium, low, etc.).

As mentioned above, the first facsimile call 322 and the second facsimile call 324 can comprise either a call originated by the first telephone number 320 or a call received by the first telephone number 320. Further, the first telephone number 320 can comprise a dedicated facsimile telephone number. After terminating the first facsimile call 322 (and after completing the second facsimile call 324) the VoIP computerized call processor 318 can execute the program of instructions 312 to resend the first facsimile call 322, if the first facsimile call 322 was originated by the first telephone number 320.

In any heavy facsimile usage environment, especially in the legal, financial, government and defense sectors, the embodiments herein help the user to receive important/urgent facsimile calls that could otherwise be lost or received late, at potentially great cost. Although heavy facsimile usage is often the fault of the user's environment, and a lack of the necessary additional facsimile resources, it can give the incorrect perception that the facsimile product is missing important facsimiles. This invention addresses this issue, thereby improving user satisfaction.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The word “printer” or “printing device” as used herein encompasses any apparatus, such as a digital copier, bookmaking machine, facsimile machine, multi-function machine, etc. which performs a print outputting function for any purpose. The details of printers, printing engines, etc. are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein should not be implied or imported from any above example as limitations to any particular order, number, position, size, shape, angle, color, or material.

What is claimed is:

1. A computer-implemented method comprising:
maintaining a facsimile number priority hierarchy within a computer storage medium;
processing a first facsimile call being transmitted through a computerized call processor, said first facsimile call being made between a first telephone number associated with said computerized call processor and a second telephone number not associated with said computerized call processor, said computerized call processor being operatively connected to said computer storage medium;
while processing said first facsimile call, receiving an indication of an attempt to connect a second facsimile call between said first telephone number and a third telephone number using said computerized call processor, said third telephone number not being associated with said computerized call processor;
determining a priority between said second telephone number and said third telephone number based on said facsimile number priority hierarchy, using said computerized call processor;
if said second telephone number has a higher priority than said third telephone number, said computerized call processor not connecting said second facsimile call by returning a busy indicator in response to said attempt to connect; and
if said third telephone number has a higher priority than said second telephone number, said computerized call processor terminating said first facsimile call and connecting said second facsimile call by connecting said third telephone number to said first telephone number.

2. The computer-implemented method according to claim 1, said determining of said priority comprising:
ranking telephone numbers not maintained within said facsimile number priority hierarchy equally;
ranking telephone numbers maintained within said facsimile number priority hierarchy higher than numbers not maintained within said facsimile number priority hierarchy; and
determining a ranking between telephone numbers maintained within said facsimile number priority hierarchy according to a structure of said facsimile number priority hierarchy.

3. The computer-implemented method according to claim 1, said first facsimile call and said second facsimile call comprising one of:
a call originated by said first telephone number; and
a call received by said first telephone number.

4. The computer-implemented method according to claim 1, further comprising, after said terminating of said first facsimile call and after completing said second facsimile call, resending said first facsimile call, if said first facsimile call was originated by said first telephone number.

5. The computer-implemented method according to claim 1, said first telephone number comprising a dedicated facsimile telephone number.

6. A computer-implemented method comprising:
maintaining a facsimile number priority hierarchy within a computer storage medium of a voice-over-internet-protocol (VoIP) computerized call apparatus;
processing a first facsimile call being transmitted through a VoIP computerized call processor of said VoIP computerized call apparatus, said first facsimile call being made between a first telephone number based in said computerized call apparatus and a second telephone number not based in said computerized call apparatus, said VoIP computerized call processor being operatively connected to said computer storage medium;
while processing said first facsimile call, receiving an indication of an attempt to connect a second facsimile call between said first telephone number and a third telephone number using said VoIP computerized call processor, said third telephone number not being based in said computerized call apparatus;
determining a priority between said second telephone number and said third telephone number based on said facsimile number priority hierarchy, using said VoIP computerized call processor;
if said second telephone number has a higher priority than said third telephone number, said VoIP computerized call processor not connecting said second facsimile call by returning a busy indicator in response to said attempt to connect; and
if said third telephone number has a higher priority than said second telephone number, said VoIP computerized call processor terminating said first facsimile call and connecting said second facsimile call by connecting said third telephone number to said first telephone number.

7. The computer-implemented method according to claim 6, said determining of said priority comprising:
ranking telephone numbers not maintained within said facsimile number priority hierarchy equally;
ranking telephone numbers maintained within said facsimile number priority hierarchy higher than numbers not maintained within said facsimile number priority hierarchy; and
determining a ranking between telephone numbers maintained within said facsimile number priority hierarchy according to a structure of said facsimile number priority hierarchy.

8. The computer-implemented method according to claim 6, said first facsimile call and said second facsimile call comprising one of:
a call originated by said first telephone number; and
a call received by said first telephone number.

9. The computer-implemented method according to claim 6, further comprising, after said terminating of said first facsimile call and after completing said second facsimile call, resending said first facsimile call, if said first facsimile call was originated by said first telephone number.

10. The computer-implemented method according to claim 6, said first telephone number comprising a dedicated facsimile telephone number.

11. A voice-over-internet-protocol (VoIP) computerized call apparatus comprising:
a computer storage medium maintaining a facsimile number priority hierarchy and a program of instructions;
a VoIP computerized call processor operatively connected to said computer storage medium, said VoIP computerized call processor executing said program of instructions to process a first facsimile call being transmitted through of said VoIP computerized call apparatus, said first facsimile call being made between a first telephone number based in said computerized call apparatus and a second telephone number not based in said computerized call apparatus,
while processing said first facsimile call, said VIOP computerized call apparatus receiving an indication of an attempt to connect a second facsimile call between said first telephone number and a third telephone number using said VoIP computerized call processor, said third telephone number not being based in said computerized call apparatus;
determining a priority between said second telephone number and said third telephone number based on said facsimile number priority hierarchy, using said VoIP computerized call processor;
if said second telephone number has a higher priority than said third telephone number, said VoIP computerized call processor executing said program of instructions to not connect said second facsimile call by returning a busy indicator in response to said attempt to connect; and
if said third telephone number has a higher priority than said second telephone number, said VoIP computerized call processor executing said program of instructions to terminate said first facsimile call and connect said second facsimile call by connecting said third telephone number to said first telephone number.

12. The VoIP computerized call apparatus according to claim 11, said determining of said priority comprising:
ranking telephone numbers not maintained within said facsimile number priority hierarchy equally;
ranking telephone numbers maintained within said facsimile number priority hierarchy higher than numbers not maintained within said facsimile number priority hierarchy; and
determining a ranking between telephone numbers maintained within said facsimile number priority hierarchy according to a structure of said facsimile number priority hierarchy.

13. The VoIP computerized call apparatus according to claim 11, said first facsimile call and said second facsimile call comprising one of:
a call originated by said first telephone number; and
a call received by said first telephone number.

14. The VoIP computerized call apparatus according to claim 11, further comprising, after said terminating of said first facsimile call and after completing said second facsimile call, said VoIP computerized call processor executing said program of instructions to resend said first facsimile call, if said first facsimile call was originated by said first telephone number.

15. The VoIP computerized call apparatus according to claim 11, said first telephone number comprising a dedicated facsimile telephone number.

16. A computer storage medium readable by computer, said computer storage medium tangibly embodying instructions executable by said computer to perform a method comprising:
maintaining a facsimile number priority hierarchy within said computer storage medium;
processing a first facsimile call being transmitted through a computerized call processor, said first facsimile call being made between a first telephone number associated with said computerized call processor and a second telephone number not associated with said computerized call processor;
while processing said first facsimile call, receiving an indication of an attempt to connect a second facsimile call between said first telephone number and a third telephone number using said computerized call processor, said third telephone number not being associated with said computerized call processor;
determining a priority between said second telephone number and said third telephone number based on said facsimile number priority hierarchy;
if said second telephone number has a higher priority than said third telephone number, said computerized call processor not connecting said second facsimile call by returning a busy indicator in response to said attempt to connect; and
if said third telephone number has a higher priority than said second telephone number, said computerized call processor terminating said first facsimile call and connecting said second facsimile call by connecting said third telephone number to said first telephone number.

17. The computer storage medium according to claim 16, said determining of said priority comprising:
ranking telephone numbers not maintained within said facsimile number priority hierarchy equally;
ranking telephone numbers maintained within said facsimile number priority hierarchy higher than numbers not maintained within said facsimile number priority hierarchy; and
determining a ranking between telephone numbers maintained within said facsimile number priority hierarchy according to a structure of said facsimile number priority hierarchy.

18. The computer storage medium according to claim 16, said first facsimile call and said second facsimile call comprising one of:
a call originated by said first telephone number; and
a call received by said first telephone number.

19. The computer storage medium according to claim 16, further comprising, after said terminating of said first facsimile call and after completing said second facsimile call, resending said first facsimile call, if said first facsimile call was originated by said first telephone number.

20. The computer storage medium according to claim 16, said first telephone number comprising a dedicated facsimile telephone number.
